(19) United States
(12) Patent Application Publication
(10) Pub. No.: US 2026/0364827 A1
(43) Pub. Date: Nov. 19, 2026

(54) Foldable Knife

(71) Applicant: Groove Life Corporation, Spring Hill, TN (US)

(72) Inventors: Peter Goodwin, Spring Hill, TN (US); Graham Stephen Harrison, Lewisburg, TN (US); Timothy Brian Chalfant, La Vergne, TN (US); Cody Bohn Hutchins, College Grove, TN (US); Salmon Antonie Nortje, Columbia, TN (US); Adam Bahl, Perkasie, PA (US); Glenn Klecker, Dundee, OR (US)

(73) Assignee: Groove Life Corporation, Spring Hill, TN (US)

(21) Appl. No.: 19/677,603

(22) Filed: May 14, 2026

Related U.S. Application Data
(60) Provisional application No. 63/805,567, filed on May 14, 2025.

(51) Int. Cl. B26B 1/04; B26B 1/10

(52) U.S. Cl. CPC B26B 1/044; B26B 1/10

(57) ABSTRACT

A foldable knife includes a handle portion and a blade pivotally coupled to the handle portion. The handle portion may define a blade channel configured to receive at least a portion of the blade. In some embodiments, the foldable knife includes first and second buttons accessible on opposite sides of the handle portion and configured to selectively restrict pivotal movement of the blade relative to the handle portion. In some embodiments, the foldable knife includes a removable scale removably securable to an exterior side of the handle portion. In some embodiments, the foldable knife includes both the first and second buttons and the removable scale.

### TECHNICAL FIELD

The subject matter disclosed herein relates to the field of knives, and in particular, to locking mechanisms for foldable knives.

### BACKGROUND

In general, foldable knives include a blade pivotally coupled with a handle assembly. Foldable knives may include a locking mechanism to prevent the blade from unintentionally pivoting between a deployed and undeployed state. For instance, one example of a locking mechanism includes a single push button positioned on a first side (i.e., a thumb side) of a handle assembly to selectively lock and/or unlock actuation of the blade.

### SUMMARY

According to one aspect, a foldable knife includes a handle portion having a first side and a second side opposite the first side, the handle portion defining a blade channel. A blade is pivotally coupled to the handle portion, and at least a portion of the blade is receivable in the blade channel. A first button is accessible on the first side of the handle portion and includes a first locking surface. A second button is accessible on the second side of the handle portion and includes a second locking surface. The first locking surface and the second locking surface engage the blade to restrict pivotal movement of the blade relative to the handle portion.

According to another aspect, a foldable knife includes a handle portion having a first side and a second side opposite the first side, the handle portion defining a blade channel. A blade is pivotally coupled to the handle portion, and at least a portion of the blade is receivable in the blade channel. A first button is accessible on the first side of the handle portion and is movable transversely relative to the first side of the handle portion between a first rest position and a first compressed position. A second button is accessible on the second side of the handle portion and is movable transversely relative to the second side of the handle portion between a second rest position and a second compressed position. Actuation of the first button to the first compressed position and the second button to the second compressed position enables pivotal movement of the blade relative to the handle portion.

According to another aspect, a knife includes a handle portion, a blade coupled to the handle portion, and a removable scale configured to be removably secured to an exterior side of the handle portion.

### BRIEF DESCRIPTION OF THE DRAWINGS

FIG. 1 is a side view of a foldable knife with a blade positioned in a deployed state, according to some embodiments.

FIG. 2 is a side view of a foldable knife with a blade positioned in an undeployed state, according to some embodiments.

FIG. 3 is an exploded isometric side view of a foldable knife, according to some embodiments.

FIG. 4 is a side view of a blade of a foldable knife, according to some embodiments.

FIG. 5 is an isometric view of a proximal end of a blade of a foldable knife, according to some embodiments.

FIG. 6 is a bottom view of a tang region of a blade of a foldable knife, according to some embodiments.

FIG. 7 is an exploded isometric side view of a blade pivotally coupled to a handle portion of a foldable knife, according to some embodiments.

FIG. 8 is an isometric side view of a first button and a blade of a foldable knife, according to some embodiments.

FIG. 9 is a cross-sectional top view of a foldable knife in a locked blade state, according to some embodiments.

FIG. 10 is a cross-sectional top view of a foldable knife in an unlocked blade state, according to some embodiments.

FIG. 11A is an isometric view of a removable scale for a handle portion of a foldable knife, according to some embodiments.

FIG. 11B is an isometric view of a removable scale for a handle portion of a foldable knife, according to some embodiments.

FIG. 12 is an isometric view of a second handle half of a handle portion of a foldable knife, according to some embodiments.

FIG. 13 is a partially exploded isometric view of a lower end of a handle portion of a foldable knife, according to some embodiments.

FIG. 14 is a view of a removable scale being removed from a handle portion of a foldable knife, according to some embodiments.

FIG. 15 is a view of a foldable knife with a removable scale removed from a handle portion, according to some embodiments.

FIG. 16 is a view of a foldable knife with one or more portions shown transparently, omitted, or cut away to show a dual-button locking mechanism, according to some embodiments.

FIG. 17 is a view of a foldable knife having a removable scale system, according to some embodiments.

FIG. 18 is a flowchart for a method of unlocking a foldable knife, according to some embodiments.

### DETAILED DESCRIPTION

The present disclosure describes devices, systems, and/or methods of a dual-button locking mechanism for a foldable knife. The foldable knife includes a blade pivotally coupled with a handle portion. The handle portion may have a first side and a second side opposite the first side and may define a blade channel configured to receive at least a portion of the blade. A first button may be accessible on the first side of the handle portion and a second button may be accessible on the second side of the handle portion. In some embodiments, the handle portion includes a first handle half and a second handle half with the blade channel positioned therebetween, the first button extends through the first handle half, and the second button extends through the second handle half. The first button may be coupled to a biased member, and the second button may be coupled to a biased member for transverse movement of the first and second buttons relative to the handle portion. The biased member may extend across the blade channel and/or extend through the blade. Both the first button and the second button are actuated to unlock the blade, i.e., to allow actuation of the blade from the deployed state to an undeployed state. The two-button (or multi-button) locking mechanism is beneficial for verifying proper hand and finger placement on the knife prior to blade actuation. For instance, actuation of the first button may be accomplished via thumb placement on the first side of the handle portion and actuation of the second button may be accomplished via finger (e.g., index finger or middle finger) placement on the second side of the handle portion, and thus, both the thumb and the finger are clear of the blade path. In contrast, a single-button locking mechanism does not require a contact point on each side of the handle, and therefore, a finger or thumb could be in the blade path.

In some embodiments, the dual-button locking mechanism may be implemented using a handle portion having a first side and a second side opposite the first side, regardless of whether the first side and the second side are provided by a unitary handle body, separate handle halves, side portions, liners, side plates, scales, frame portions, body portions, or other handle structures. References herein to a first side and a second side of a handle portion do not require that the handle portion be formed from separate first and second handle halves. In some embodiments, the handle portion includes a single handle body defining the first side and the second side. In some embodiments, the handle portion includes a unitary handle body defining the first side and the second side. In some embodiments, the handle portion includes two or more coupled handle structures that together define the first side and the second side. In some embodiments, the two or more coupled handle structures include one or more handle halves, liners, side plates, scales, frame portions, body portions, spacers, inserts, or other handle components. In some embodiments, the first button is accessible on the first side of the handle portion and the second button is accessible on the second side of the handle portion. In some embodiments, the handle portion includes the first handle half and the second handle half with the blade channel positioned therebetween.

The present disclosure also describes devices, systems, and/or methods of a removable scale system for a knife. The removable scale system may include a removable scale configured to be removably secured to an exterior side of a handle portion of the knife. In some embodiments, the removable scale may be secured to the handle portion by mechanical coupling, magnetic coupling, frictional retention, snap-fit retention, clip-fit retention, sliding engagement, or combinations thereof. In some embodiments, the removable scale may be secured to the handle portion without threaded and/or through-hole fasteners extending through the removable scale. The removable scale system may be beneficial, as different removable scales having different aesthetic features and/or ergonomic features can be quickly and efficiently removed from the handle portion and replaced with a different removable scale without the use of tools and/or external fasteners.

The dual-button locking mechanism and the removable scale system may be implemented separately or together. In some embodiments, a foldable knife includes the dual-button locking mechanism without the removable scale system. In some embodiments, a knife includes the removable scale system without the dual-button locking mechanism. In some embodiments, a foldable knife includes both the dual-button locking mechanism and the removable scale system. Unless expressly stated otherwise, features described with respect to the dual-button locking mechanism may be used with or without the removable scale system, and features described with respect to the removable scale system may be used with or without the dual-button locking mechanism.

In some embodiments, the removable scale system includes a removable scale configured to be removably secured to an exterior side of a handle portion. The removable scale may be retained relative to the handle portion by magnetic retention, mechanical retention, frictional retention, snap-fit retention, clip-fit retention, sliding engagement, or combinations thereof. In some embodiments, magnetic retention, mechanical retention, frictional retention, snap-fit retention, clip-fit retention, and sliding engagement are optional features that may be used individually or in any suitable combination.

In some embodiments, the removable scale is magnetically securable to the handle portion. One or more magnetic components may be disposed in the removable scale, in the handle portion, or in both the removable scale and the handle portion. In some embodiments, a magnetic component of the removable scale cooperates with a magnetic component or magnetically attractable portion of the handle portion. In some embodiments, a magnetic component of the handle portion cooperates with a magnetic component or magnetically attractable portion of the removable scale. In some embodiments, the magnetically attractable portion includes a ferromagnetic material, steel, iron, nickel, cobalt, an alloy thereof, a plate, insert, region, or other structure attracted by the magnetic component.

In some embodiments, the removable scale is mechanically retained relative to the handle portion. The mechanical retention may include one or more lips, tabs, overhangs, projections, recesses, slots, snap-fit features, clip-fit features, friction-fit features, sliding engagement features, flexible retention features, or combinations thereof. In some embodiments, a first portion of the removable scale is moved under or behind a lip, tab, or overhang of the handle portion, and a second portion of the removable scale is moved toward the handle portion to engage a snap-fit feature, clip-fit feature, friction-fit feature, magnetic coupling, or combinations thereof.

In some embodiments, a removable scale is provided on only one exterior side of the handle portion. In some embodiments, removable scales are provided on both exterior sides of the handle portion. In some embodiments, each removable scale is independently removable from the handle portion.

In some embodiments, the removable scale conceals one or more fasteners, openings, recesses, retention features, or other handle-side structures when the removable scale is installed. In some embodiments, the removable scale is secured to the handle portion without externally visible fasteners extending through the removable scale. In other embodiments, one or more externally visible fasteners may remain visible, such as a fastener associated with a pocket clip or another component.

In some embodiments, the removable scale is configured so that a button of the dual-button locking mechanism remains visible or accessible when the removable scale is installed. In some embodiments, the button need not define a pivot axis of the blade.

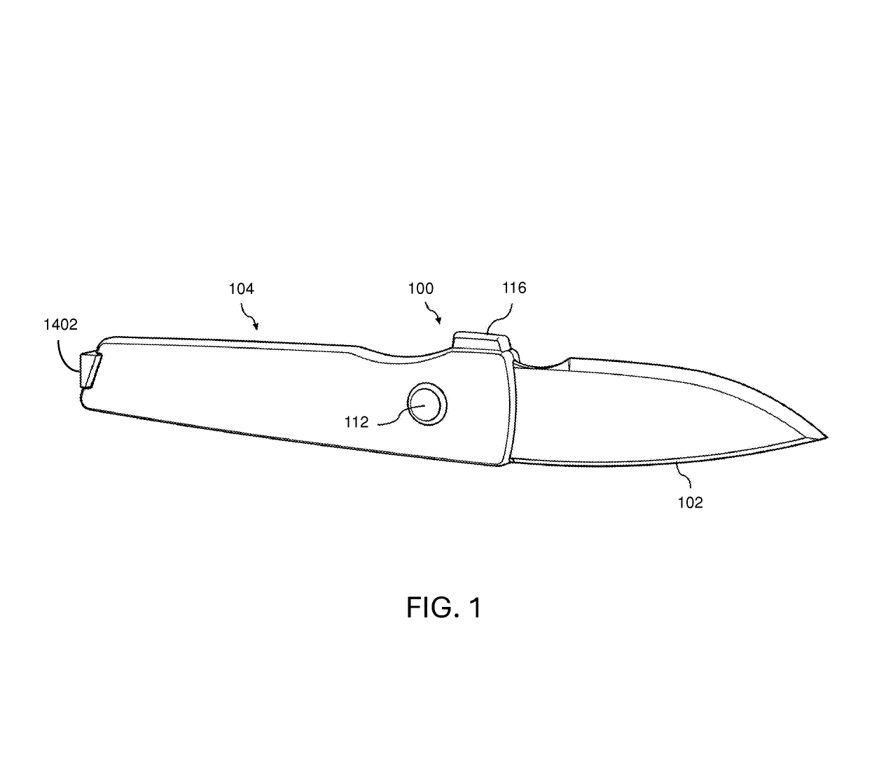

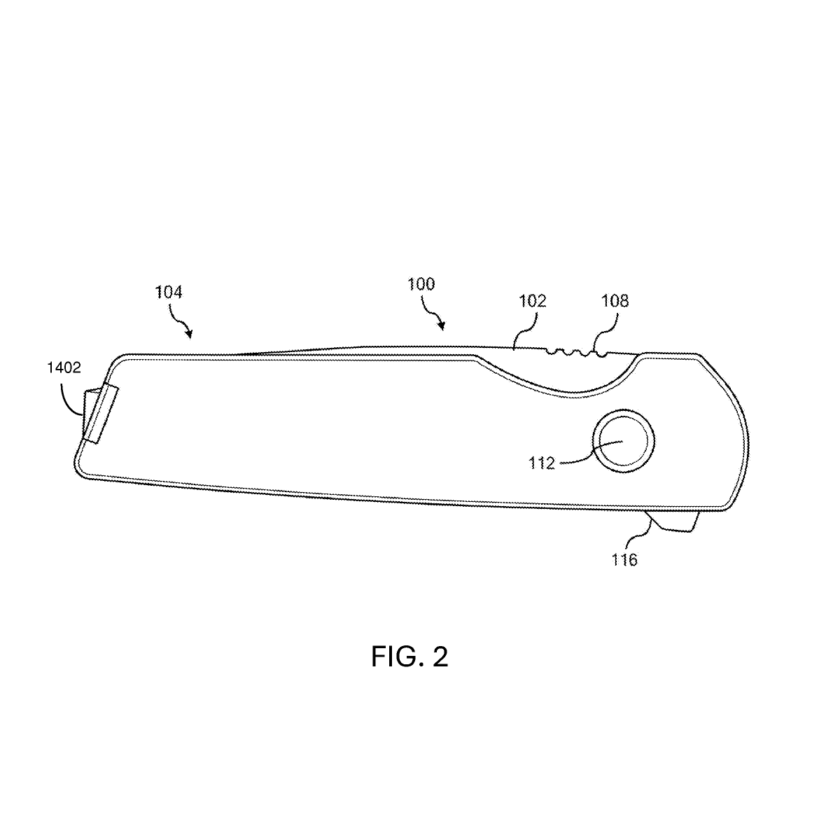

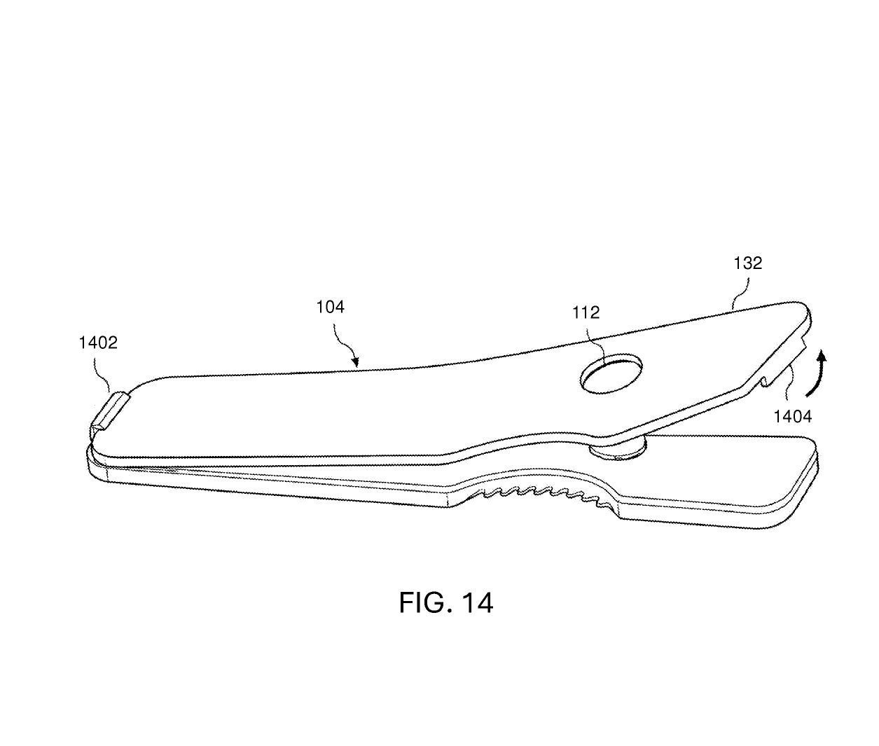

FIG. 1 is a side view of a foldable knife 100 with a blade 102 positioned in a deployed state, according to some embodiments. The foldable knife 100 includes a handle portion 104, a first button 112, and a shoulder 116. FIG. 2 is a side view of the foldable knife 100 with the blade 102 positioned in an undeployed state, according to some embodiments. The foldable knife 100 includes the blade 102 pivotally secured to the handle portion 104. The handle portion 104 may define a blade channel 148 configured to receive the blade 102 therein. The blade 102 may include a tactile region 108. The blade 102 may pivot relative to the handle portion 104 via user manipulation of the blade 102, and may be restrained in one or more positions by a dual-button locking mechanism. The first button 112 may include a user engagement surface and/or one or more lock engagement features. In some embodiments, the handle portion 104 includes one or more handle-side retention features 1402 configured to retain a removable scale relative to the handle portion 104, as described in further detail with respect to FIG. 14.

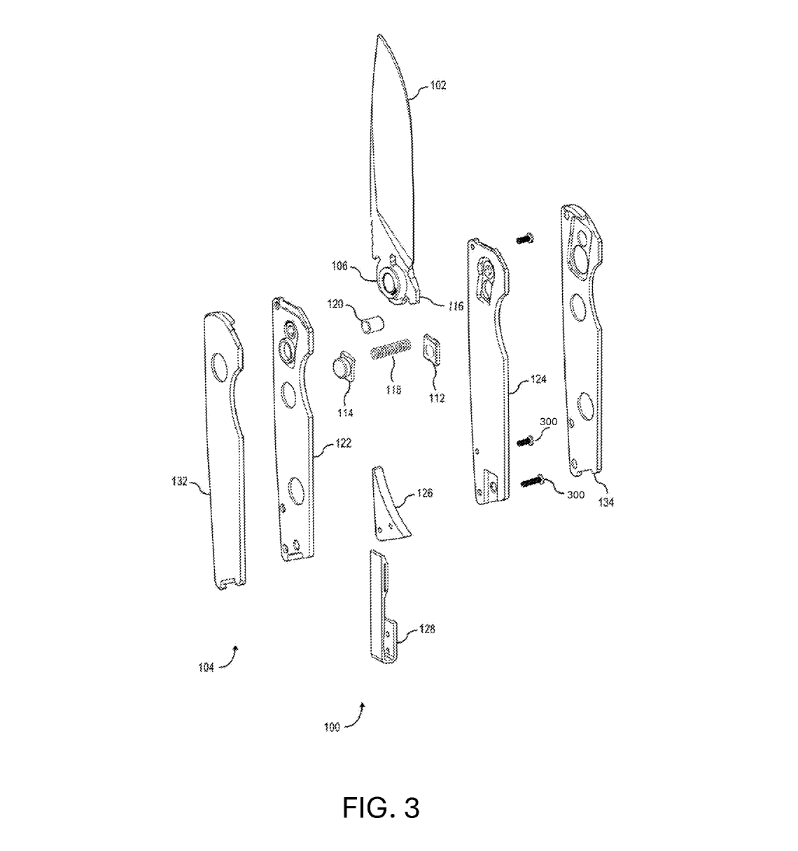

FIG. 3 is an exploded isometric side view of the foldable knife 100, according to some embodiments. The foldable knife 100 includes the blade 102 having a tang 106, the first button 112 and a second button 114, a biased member 118, and a bushing 120. The biased member 118 may be disposed between the first button 112 and the second button 114. The biased member 118 may extend through the curved slot 136 of the tang 106. The handle portion 104 includes a first handle half 122 and a second handle half 124. In some embodiments, the handle portion 104 includes a spacer 126 and a clip 128. The handle portion 104 may include a first removable scale 132 and a second removable scale 134. In the illustrated embodiment, the blade channel 148 is positioned between the first handle half 122 and the second handle half 124. It should be noted that the term handle half does not require the first handle half 122 and the second handle half 124 to have an equal mass or size. The first handle half 122 may be disposed on a first side of the blade 102 and the second handle half 124 may be disposed on a second side of the blade 102 opposite the first side. The first button 112 may extend through the first handle half 122 and the second button 114 may extend through the second handle half 124 such that a user may access the first button 112 and the second button 114 on the handle portion 104. The first button 112 and the second button 114 may be movable transversely of the first handle half 122 and the second handle half 124. In some embodiments, the biased member 118 is biased to urge the first button 112 and the second button 114 toward respective rest positions. In some embodiments, the biased member 118 is a spring, which may be referred to as a button spring. In some embodiments, the first button 112 and the second button 114 are movable via compression of the biased member 118. The first button 112 may be in mechanical communication with the second button 114 via the biased member 118.

In the illustrated embodiment of FIG. 3, the foldable knife 100 includes both the dual-button locking mechanism and the removable scale system. In other embodiments, the dual-button locking mechanism may be used without the removable scale system. In other embodiments, the removable scale system may be used without the dual-button locking mechanism. Accordingly, although certain features are shown together in FIG. 3, the dual-button locking mechanism and the removable scale system may be implemented separately or together unless expressly stated otherwise. The first handle half 122 and the second handle half 124 may define respective first and second sides of the handle portion 104. In other embodiments, the first and second sides of the handle portion 104 may be defined by other handle structures, side portions, liners, frame portions, body portions, or combinations thereof.

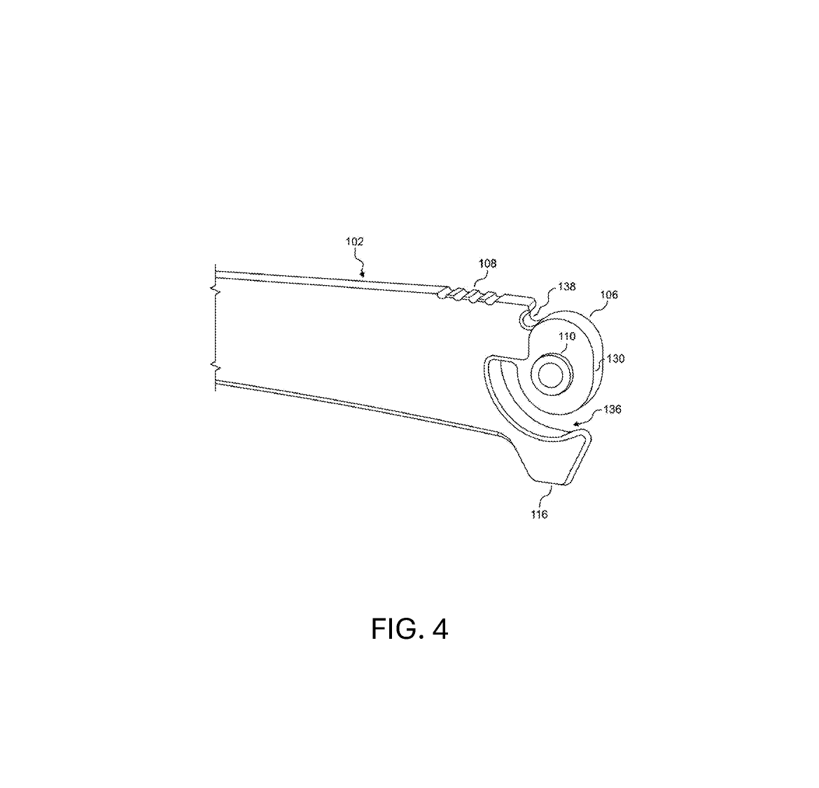

FIG. 4 is a side view of the blade 102 of the foldable knife 100, according to some embodiments. The blade 102 includes the tang 106 having a pivot aperture 110, a blade protrusion 130, a curved slot 136, and a secondary slot 138. The blade 102 may be pivotally coupled to the handle portion 104 via the pivot aperture 110, including, for example, the bushing 120 extending through the pivot aperture 110. In some embodiments, the biased member 118 extends through the tang 106 of the blade 102. For instance, the biased member 118 may be received within or extends through the curved slot 136 of the tang 106. In other embodiments, the biased member 118 is positioned outside the curved slot 136, adjacent the tang 106, around the tang 106, through another opening of the blade 102, or otherwise arranged relative to the blade 102 and the handle portion 104 while operably biasing the first button 112 and the second button 114. The blade protrusion 130 may include one or more surfaces configured to engage the first button 112 and/or the second button 114 to restrict pivotal movement of the blade 102 relative to the handle portion 104.

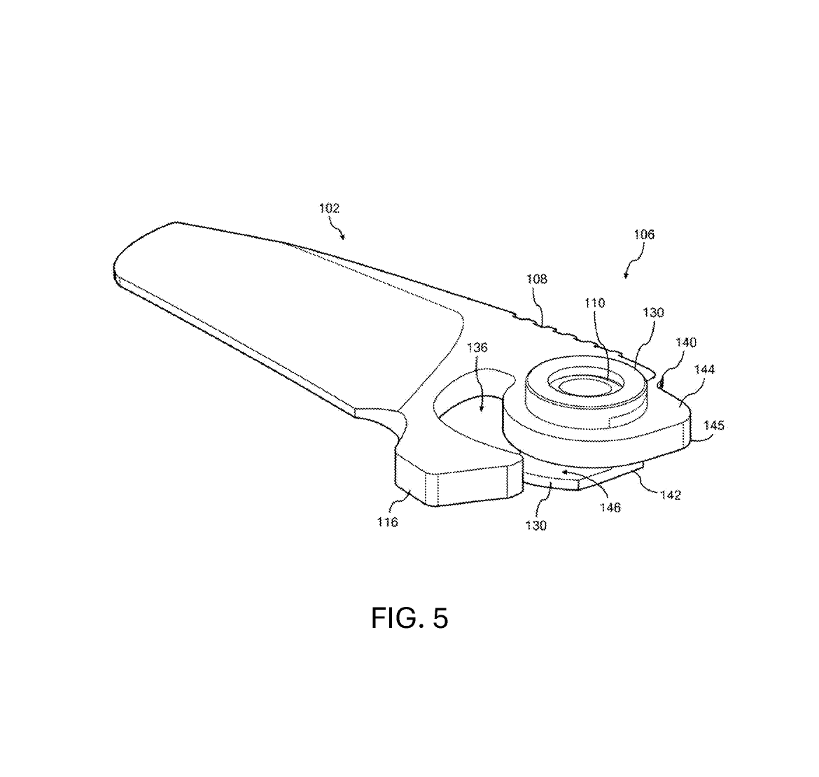

FIG. 5 is an isometric view of a proximal end of the blade 102 of the foldable knife 100, according to some embodiments. The tang 106 includes the blade protrusion 130 having a first engagement surface 140 on a first side 145 of the blade 102 and a second engagement surface 142 on a second side 147 of the blade 102. The first side 145 of the blade 102 is opposite the second side 147 of the blade 102. The blade protrusion 130 includes a first channel 144 and a second channel 146. The first channel 144 may be inboard from the first engagement surface 140 and the second channel 146 may be inboard from the second engagement surface 142.

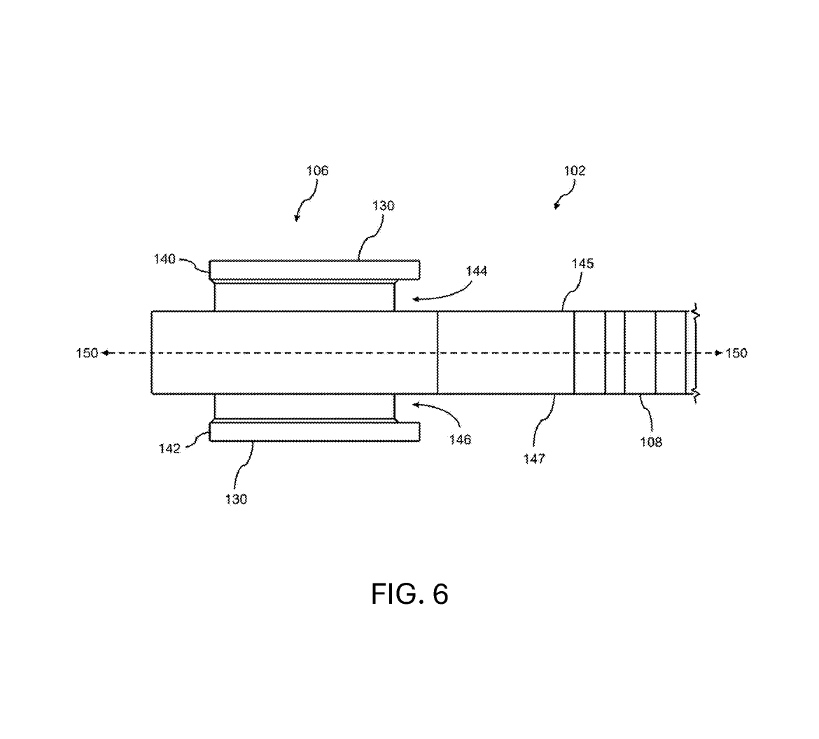

FIG. 6 is a bottom view of a tang region of the blade 102 of the foldable knife 100, according to some embodiments. The blade 102 includes a longitudinal centerline 150 extending from the proximal end, such as the tang 106, toward the distal tip. The first engagement surface 140 of the blade protrusion 130 may extend transverse from the longitudinal centerline 150 on the first side 145 of the blade 102. The second engagement surface 142 of the blade protrusion 130 may extend transverse from the longitudinal centerline 150 on the second side 147 of the blade 102. The first channel 144 may be positioned between the first engagement surface 140 and the longitudinal centerline 150. The second channel 146 may be positioned between the second engagement surface 142 and the longitudinal centerline 150.

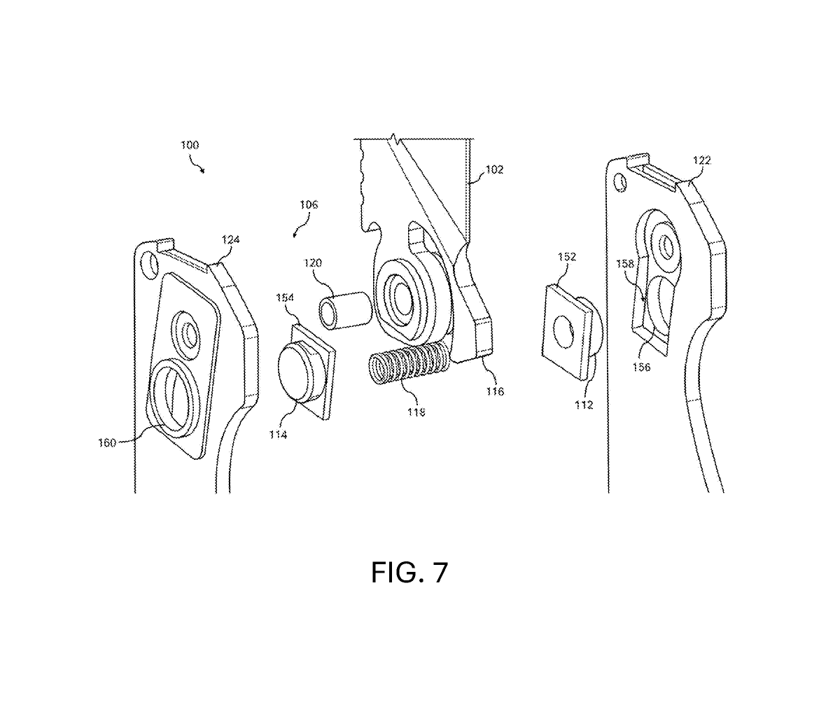

FIG. 7 is an exploded isometric side view of the blade 102 pivotally coupled to the handle portion 104 of the foldable knife 100, according to some embodiments. The first button 112 includes a first locking surface 152. The first button 112 may be received within a first recess 158 of the first handle half 122 and/or the first button 112 may be received within a first button aperture 156 of the first handle half 122. The second button 114 includes a second locking surface 154. The second button 114 may be received within a second recess of the second handle half 124 and/or the second button 114 may be received within a second button aperture 160 of the second handle half 124.

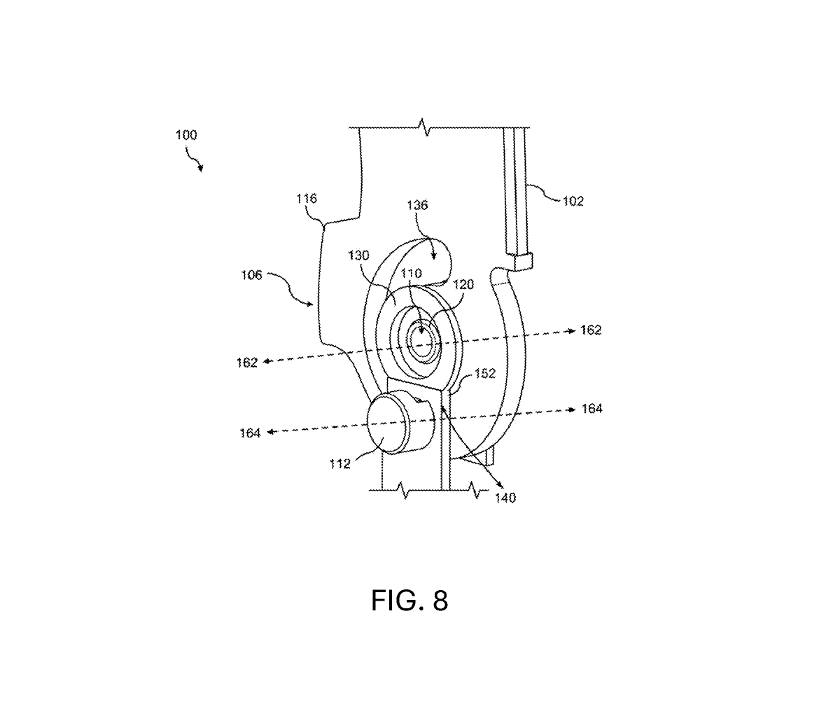

FIG. 8 is an isometric side view of the first button 112 and the blade 102 of the foldable knife 100, according to some embodiments. The foldable knife 100 includes a pivot axis 162 extending through the pivot aperture 110. The blade 102 is pivotable about the pivot axis 162. A button axis 164 extends between the first button 112 and the second button 114. The first button 112 and the second button 114 may be movable along the button axis 164. The button axis 164 may be offset from the pivot axis 162. For example, the button axis 164 does not intersect with the pivot axis 162. The first engagement surface 140 of the blade protrusion 130 may be configured to engage the first locking surface 152 of the first button 112.

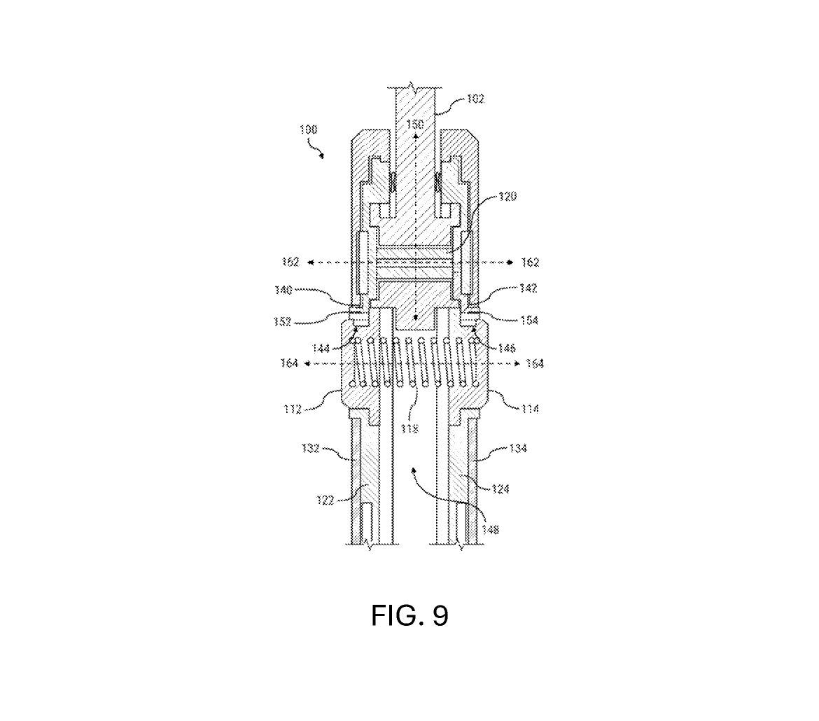

FIG. 9 is a cross-sectional top view of the foldable knife 100 in a locked blade state, according to some embodiments. The foldable knife 100 includes the blade channel 148 positioned between the first handle half 122 and the second handle half 124. In the locked blade state, the first locking surface 152 and the second locking surface 154 are engaged with the blade 102, such as the blade protrusion 130, to restrict pivotal movement of the blade 102 relative to the handle portion 104. In some embodiments, the first engagement surface 140 of the blade protrusion 130 engages the first locking surface 152 of the first button 112 and the second engagement surface 142 of the blade protrusion 130 engages the second locking surface 154 of the second button 114. In some embodiments, the biased member 118 urges the first button 112 in a first transverse direction relative to the longitudinal centerline 150 of the blade 102 and urges the second button 114 in a second transverse direction relative to the longitudinal centerline 150 of the blade 102. In some embodiments, the biased member 118 urges the first button 112 and the second button 114 outboard of, or transversely away from, the longitudinal centerline 150 of the blade 102 such that the first locking surface 152 and the second locking surface 154 are positioned to engage the blade protrusion 130.

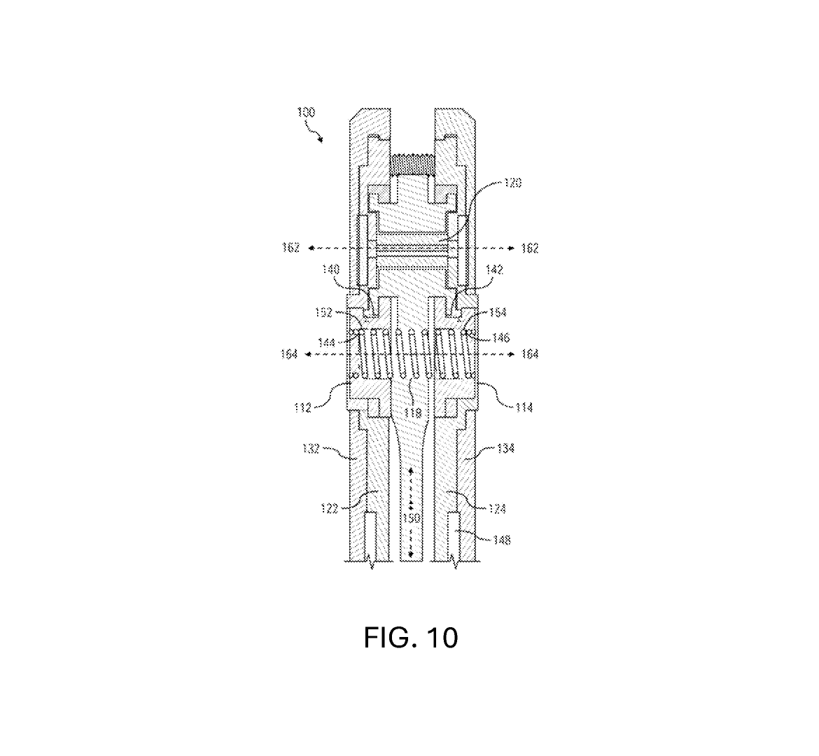

FIG. 10 is a cross-sectional top view of the foldable knife 100 in an unlocked blade state, according to some embodiments. The first button 112 and the second button 114 are compressed toward the longitudinal centerline 150 of the blade 102 such that the first locking surface 152 and the second locking surface 154 are disengaged from the blade protrusion 130. The first locking surface 152 of the first button 112 is positioned between the first engagement surface 140 and the longitudinal centerline 150, and the second locking surface 154 of the second button 114 is positioned between the second engagement surface 142 and the longitudinal centerline 150. The first locking surface 152 may be received within the first channel 144 of the blade protrusion 130 and the second locking surface 154 may be received within the second channel 146 of the blade protrusion 130.

To actuate the blade 102 of the foldable knife 100 from the deployed and locked state to the undeployed state, both the first button 112 and the second button 114 are moved, such as pressed, transversely relative to the longitudinal centerline 150 of the blade 102. In some embodiments, actuation of the first button 112 or the second button 114 may include pressing, sliding, translating, pivoting, rocking, displacing, or otherwise moving the first button 112 or the second button 114 relative to the handle portion 104. In some embodiments, the first button 112 or the second button 114 may move transversely relative to the handle portion 104, longitudinally relative to the handle portion 104, arcuately, or along another actuation path.

The first button 112 is accessible on the first handle half 122, located on a first side of the longitudinal centerline 150, and the second button 114 is accessible on the second handle half 124, located on a second side of the longitudinal centerline 150 opposite the first side. Positioning the first button 112 on a first side and the second button 114 on a second side of the longitudinal centerline 150 may be beneficial to verify proper hand and finger placement on the handle portion 104 prior to pivoting of the blade 102. For example, user actuation of the first button 112 may be accomplished by a first finger or thumb and user actuation of the second button 114 may be accomplished by a second finger, and thus, both the first finger or thumb and the second finger are clear of the blade path. The handle portion 104 of the foldable knife 100 is generally held by the user via contact upon at least two surfaces, and thus, positioning the first button 112 on a first side and the second button 114 on a second side of the longitudinal centerline 150 provides safe contact points for the user as the blade 102 pivots about the pivot axis 162. In some embodiments, actuation of only one of the first button 112 or the second button 114 is insufficient to enable pivotal movement of the blade 102 relative to the handle portion 104, and concurrent actuation of both the first button 112 and the second button 114 enables pivotal movement of the blade 102 relative to the handle portion 104.

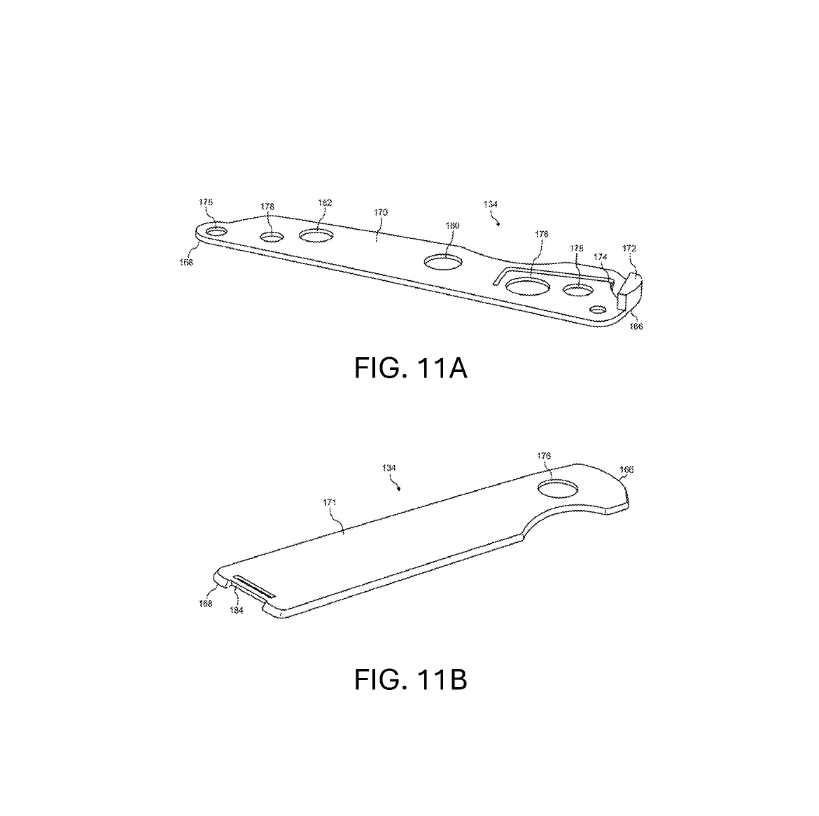

FIG. 11A is an isometric view of a removable scale 134 for the handle portion 104 of the foldable knife 100, according to some embodiments. The removable scale 134 includes an upper end 166 and a lower end 168, an inner surface 170, an upper attachment feature 172 including a cantilevered member 174, a button aperture 176, one or more inner surface depressions 178, a first magnet recess 180, and a second magnet recess 182. The removable scale 134 may be configured to mechanically and/or magnetically couple with the handle portion 104, such as the second handle half 124 in the illustrated embodiment. The first magnet recess 180 may receive a first magnet therein and the second magnet recess 182 may receive a second magnet therein. The upper attachment feature 172 may extend toward the longitudinal centerline 150 of the blade 102 and/or the cantilevered member 174 may extend toward the lower end 168 of the removable scale 134. The button aperture 176 may be configured to receive a button, such as the first button 112 or the second button 114, therein. The inner surface depressions 178 may be configured to receive fasteners or protrusions from the handle portion 104 to provide a mechanical coupling and/or alignment with the handle portion 104.

Although the removable scale 134 is described with certain attachment features, one or more of the upper attachment feature 172, the cantilevered member 174, the button aperture 176, the one or more inner surface depressions 178, the first magnet recess 180, and the second magnet recess 182 may be omitted, modified, repositioned, or used in combination with other retention features in other embodiments. In some embodiments, the removable scale 134 includes one or more magnetic components received in one or more slots, pockets, cavities, or recesses. In some embodiments, the removable scale 134 is mechanically retained by one or more lips, tabs, overhangs, projections, recesses, slots, snap-fit features, clip-fit features, friction-fit features, sliding engagement features, flexible retention features, or combinations thereof.

FIG. 11B is an isometric view of the removable scale 134 for the handle portion 104 of the foldable knife 100, according to some embodiments. The removable scale 134 includes the upper end 166 and the lower end 168, an outer surface 171, and a lower attachment feature 184. The outer surface 171 may be customized for an aesthetic appeal and/or ergonomic fit with the user. The lower attachment feature 184 may include a recess or channel configured to receive a portion of the handle portion 104.

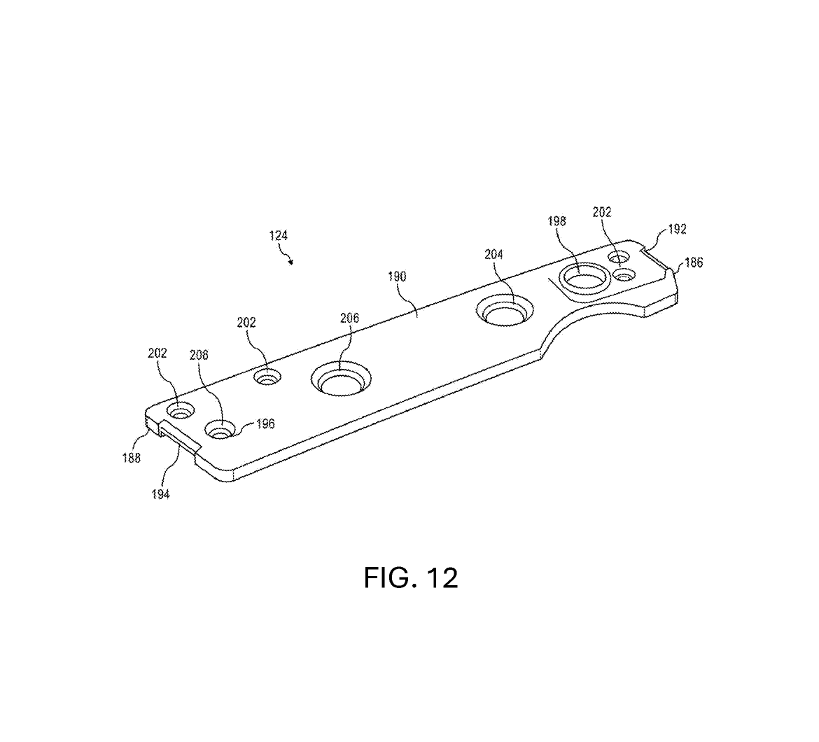

FIG. 12 is an isometric view of a second handle half 124 of the handle portion 104 of the foldable knife 100, according to some embodiments. In the illustrated embodiment, the second handle half 124 provides a handle-side body portion configured to interface with a removable scale. The second handle half 124 may include an upper end 186, a lower end 188, an outer surface 190, an upper attachment feature 192, a lower attachment feature 194, a cantilevered member 196, a button aperture 198, one or more outer surface depressions 202, a first magnet recess 204, a second magnet recess 206, and a clip aperture 208. The upper attachment feature 192 may be configured to mechanically couple with the upper attachment feature 172 of the removable scale 134. The lower attachment feature 194 may be configured to mechanically couple with the lower attachment feature 184 of the removable scale 134. The first magnet recess 204 may be configured to receive a first magnet and the second magnet recess 206 may be configured to receive a second magnet. The first and second magnets received within the first magnet recess 180 and the second magnet recess 182 of the removable scale 134 may include a first magnetic polarity, and the first and second magnets received within the first magnet recess 204 and the second magnet recess 206 of the second handle half 124 may include a second magnetic polarity opposite to and attracted to the first magnetic polarity. The second handle half 124 may be magnetically coupled to the removable scale 134. The button aperture 198 may be substantially aligned with the button aperture 176 to allow a button, such as the first button 112 or the second button 114, to extend therethrough.

Although FIG. 12 illustrates the handle-side scale interface on the second handle half 124, the same or similar interface features may be provided on another exterior side, side portion, liner, frame portion, or body portion of the handle portion 104. In some embodiments, one or more of the first magnet recess 204, the second magnet recess 206, the upper attachment feature 192, the lower attachment feature 194, the cantilevered member 196, and the one or more outer surface depressions 202 are optional features that may be used individually or in any suitable combination with other scale-retention features. In some embodiments, the cantilevered member 196 is an example of a handle-side retention feature configured to retain a removable scale relative to the handle portion 104. In some embodiments, the handle-side retention feature 1402 described with respect to FIG. 14 may include a cantilevered member, protrusion, hook, lip, tab, overhang, ledge, projection, clip-like structure, or other retention structure.

The removable scale 134 may be mechanically and magnetically coupled to the handle portion 104 without threaded and/or through-hole fasteners. The mechanical and magnetic coupling described above may be beneficial, as different removable scales 134 having different aesthetic features and/or ergonomic features can be quickly and efficiently removed from the handle portion 104 and replaced with a new removable scale 134. For example, a removable scale 134 having a first aesthetic design on the outer surface 171, such as a wood pattern, can be removed and replaced with a removable scale 134 having a second aesthetic design on the outer surface 171, such as a solid color pattern, without the use of tools and/or external fasteners.

The mechanical fit between the removable scale 134 and the handle portion 104, such as the second handle half 124 in the illustrated embodiment, along with the magnetic coupling between the removable scale 134 and the handle portion 104, such as the second handle half 124 in the illustrated embodiment, may provide sufficient retention force as to avoid unintentional disassembly. The magnetic features may ensure proper seating and alignment between the removable scale 134 and the handle portion 104, such as the second handle half 124 in the illustrated embodiment. The engagement between the upper attachment feature 192 and the upper attachment feature 172 may include a press fit or snap fit. The engagement between the lower attachment feature 194 and the lower attachment feature 184 may include a press fit or snap fit.

In some embodiments, the mechanical fit and the magnetic coupling are used together. In other embodiments, the removable scale 134 is retained relative to the handle portion 104 by magnetic retention without mechanical retention, or by mechanical retention without magnetic retention. In some embodiments, the removable scale 134 is retained relative to the handle portion 104 by mechanical retention without any magnetic component. In some embodiments, the removable scale 134 is one of a plurality of interchangeable removable scales having different exterior shapes, colors, materials, textures, finishes, graphics, decorative features, or ergonomic profiles while using a common retention interface.

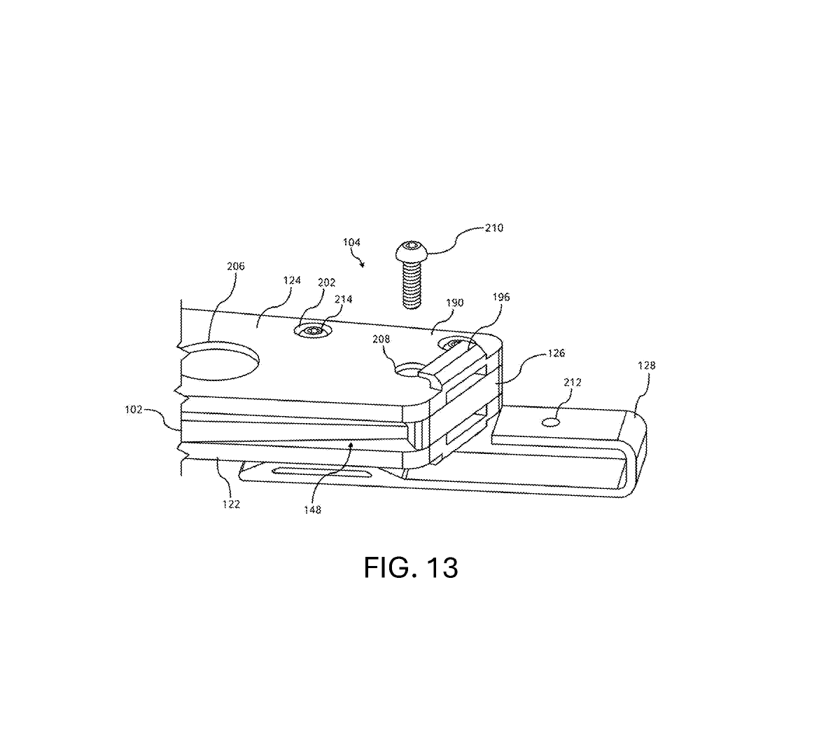

FIG. 13 is a partially exploded isometric view of a lower end of the handle portion 104 of the foldable knife 100, according to some embodiments. The foldable knife 100 includes a clip fastener 210 receivable through the clip aperture 208 of the second handle half 124 and through a second clip aperture 212 of the clip 128. The spacer 126 is positioned between the first handle half 122 and the second handle half 124 to provide the blade channel 148 for receiving the blade 102 therein. A fastener 214 is received within the one or more outer surface depressions 202. The fastener 214 may protrude from the outer surface 190 such that a portion of the fastener 214 may be received within the inner surface depressions 178 of the removable scale 134. The cantilevered member 196 of the lower attachment feature 194 may extend toward the upper end 186.

FIG. 14 is a view of the removable scale 132 being removed from the handle portion 104 of the foldable knife 100, according to some embodiments. In the illustrated embodiment, a first portion of the removable scale 132 is moved away from the handle portion 104 while another portion of the removable scale 132 remains engaged with the handle portion 104. In some embodiments, the first portion of the removable scale 132 may be lifted, flexed, pivoted, or otherwise displaced relative to the handle portion 104 to release a snap fit, clip fit, friction fit, flexible retention feature, magnetic coupling, or other retention feature. In some embodiments, the removable scale 132 defines an aperture, recess, opening, or clearance feature 1400 through which the first button 112 or the second button 114 is visible or accessible when the removable scale 132 is secured to the handle portion 104. In some embodiments, the aperture, recess, opening, or clearance feature 1400 moves with the removable scale 132 relative to the first button 112 or the second button 114, thereby exposing at least a portion of the handle portion 104 or one or more internal components beneath the removable scale 132.

In some embodiments, the removable scale 132 is retained relative to the handle portion 104 by one or more handle-side retention features 1402 and one or more scale-side engagement features 1404. In some embodiments, each handle-side retention feature 1402 includes a protrusion, hook, lip, tab, overhang, ledge, projection, clip-like structure, recess, slot, snap-fit feature, clip-fit feature, friction-fit feature, sliding engagement feature, flexible retention feature, or combinations thereof. In some embodiments, each scale-side engagement feature 1404 includes an edge, recess, notch, undercut, lip, tab, slot, shoulder, catch surface, mating projection, or other structure of the removable scale 132 configured to engage a corresponding handle-side retention feature 1402. In some embodiments, a plurality of handle-side retention features 1402 engage a plurality of scale-side engagement features 1404 to retain the removable scale 132 relative to the handle portion 104.

In some embodiments, the handle portion 104 has a layered construction. For instance, the handle portion 104 may include the removable scale 132 as an outer layer, one or more middle structures 1406, and a lower layer 1408, such as a lower scale or lower exterior member. In some embodiments, the removable scale 132 is lifted away from the handle portion 104 while the one or more middle structures 1406 and the lower layer 1408 remain attached. In some embodiments, a back portion, tang portion, grip portion, or other portion of the blade 102 is visible within the handle portion 104 when the removable scale 132 is moved away from the handle portion 104.

Although FIG. 14 illustrates one removal operation, other removal operations may be used. In some embodiments, the removable scale 132 is removed by lifting a first portion and then sliding the removable scale 132 relative to the handle portion 104. In some embodiments, the removable scale 132 is removed by sliding the removable scale 132 before lifting a portion of the removable scale 132 away from the handle portion 104. In some embodiments, the removable scale 132 is removed by flexing, pulling, rotating, pivoting, translating, or otherwise moving the removable scale 132 relative to the handle portion 104. In some embodiments, installation of the removable scale 132 may be performed by reversing one or more of the removal operations described with respect to FIG. 14.

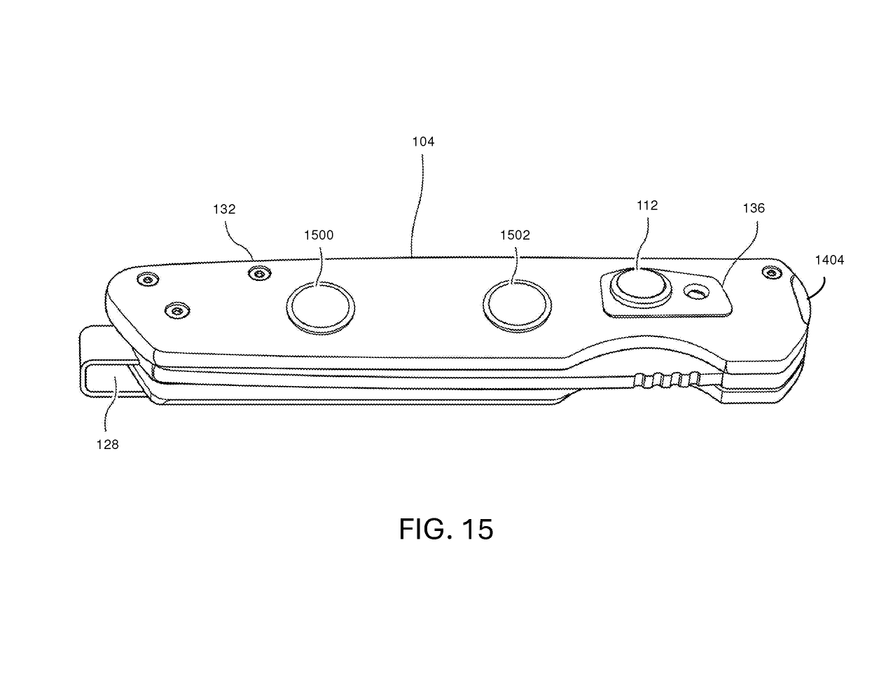

FIG. 15 is a view of the foldable knife 100 with the removable scale 132 removed from the handle portion 104, according to some embodiments. The foldable knife 100 may include the handle portion 104 and the blade 102 at least partially receivable within the handle portion 104. In some embodiments, removal of the removable scale 132 exposes at least a portion of the handle portion 104, the first button 112, the second button 114, the aperture, recess, opening, or clearance feature 1400, the one or more middle structures 1406, the lower layer 1408, one or more screw fasteners 300, or combinations thereof. In some embodiments, the one or more screw fasteners 300 are configured to couple one or more parts of the handle portion 104 together. In some embodiments, the one or more screw fasteners 300 couple together one or more of the first handle half 122, the second handle half 124, the one or more middle structures 1406, the lower layer 1408, the spacer 126, the clip 128, another handle structure, or combinations thereof. In some embodiments, the handle portion 104 includes a first magnetic component 1500 and a second magnetic component 1502 positioned in, beneath, or adjacent respective recesses, receiving regions, pockets, seats, or alignment regions of the handle portion 104.

In some embodiments, the removable scale 132 includes a first corresponding magnetic component or magnetically attractable portion 1504 and a second corresponding magnetic component or magnetically attractable portion 1506. The first magnetic component 1500 of the handle portion 104 may magnetically cooperate with the first corresponding magnetic component or magnetically attractable portion of the removable scale 132, and the second magnetic component 1502 of the handle portion 104 may magnetically cooperate with the second corresponding magnetic component or magnetically attractable portion of the removable scale 132. In some embodiments, one of each cooperating pair includes a magnet and the other of each cooperating pair includes a magnet or a magnetically attractable material. In some embodiments, the removable scale 132 is removably securable to the handle portion 104 without an externally visible fastener extending through the removable scale 132.

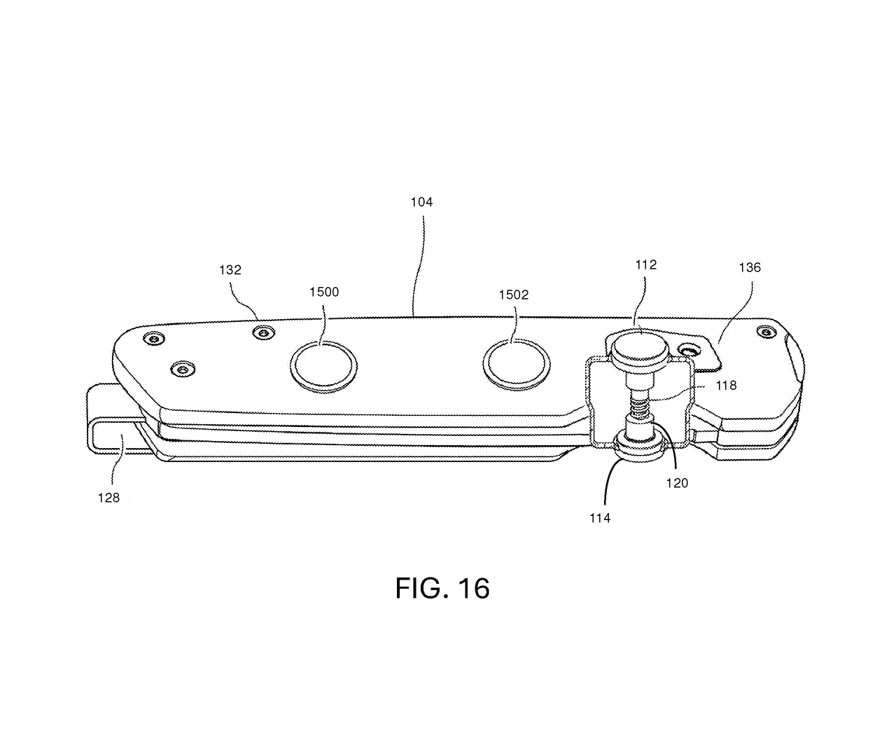

FIG. 16 is a view of the foldable knife 100 of FIG. 15 with one or more portions of the handle portion 104 shown transparently, omitted, or cut away to show the dual-button locking mechanism, according to some embodiments. In some embodiments, the dual-button locking mechanism includes the first button 112 accessible on a first side of the handle portion 104, the second button 114 accessible on a second side of the handle portion 104, and the biased member 118 operably associated with the first button 112 and the second button 114. In some embodiments, the bushing 120, the blade 102, the tang 106, one or more screw fasteners 300, the first magnetic component 1500, the second magnetic component 1502, or combinations thereof are visible through or relative to the one or more transparent, omitted, or cut-away portions. The one or more screw fasteners 300 may be configured to couple together one or more parts of the handle portion 104 while permitting the removable scale 132 to be removed from the handle portion 104. In some embodiments, the first button 112 need not define a pivot axis of the blade 102. In some embodiments, actuation of only one of the first button 112 or the second button 114 is insufficient to enable pivotal movement of the blade 102 relative to the handle portion 104, and concurrent actuation of both the first button 112 and the second button 114 enables pivotal movement of the blade 102 relative to the handle portion 104.

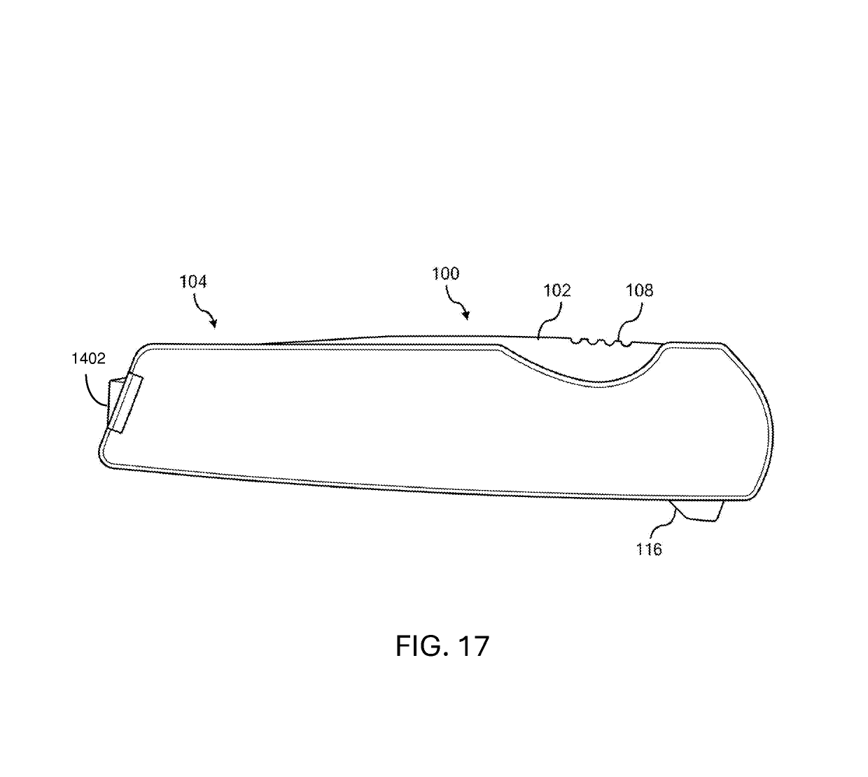

FIG. 17 is a view of a foldable knife having a removable scale system, according to some embodiments. The foldable knife includes a handle portion, a blade pivotally coupled to the handle portion, and a removable scale removably securable to an exterior side of the handle portion. In some embodiments, the removable scale is magnetically securable to the handle portion, mechanically securable to the handle portion, or both magnetically and mechanically securable to the handle portion. In some embodiments, the removable scale is retained relative to the handle portion by one or more magnetic components, magnetically attractable portions, retention features, friction-fit features, snap-fit features, clip-fit features, sliding engagement features, lips, tabs, overhangs, or combinations thereof. In some embodiments, one or more screw fasteners couple parts of the handle portion together, and the removable scale conceals at least one of the one or more screw fasteners when the removable scale is secured to the handle portion. In some embodiments, the removable scale system shown in FIG. 17 may include any of the magnetic securement, mechanical securement, retention, removal, installation, and interchangeable-scale features described with respect to FIGS. 11A-16.

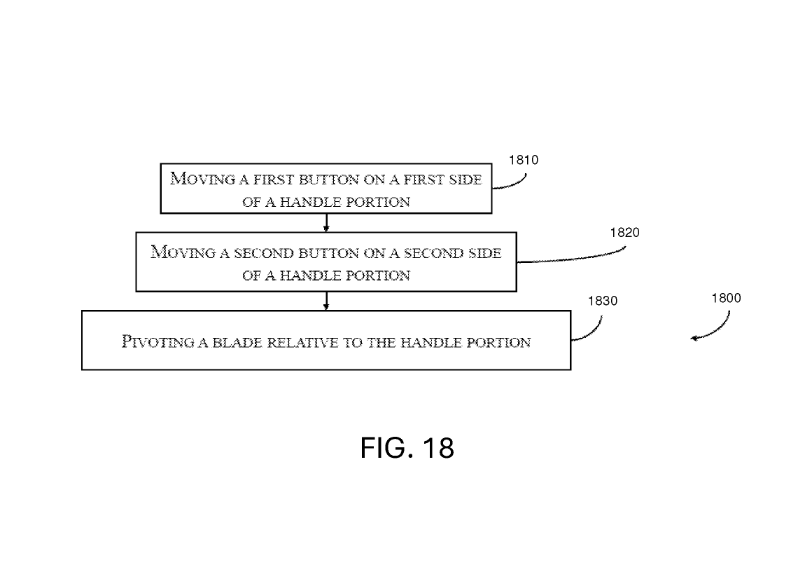

FIG. 18 is a flowchart for a method 1800 of unlocking a foldable knife, according to some embodiments. The foldable knife may include any and/or all features of the foldable knife 100 described above. At step 1810, the method 700 may include moving a first button, such as the first button 112, on a first side of a handle portion transversely of a blade. At step 1820, the method 1800 may include moving a second button, such as the second button 114, on a second side of a handle portion transversely of a blade. The second side may be opposite the first side of the handle portion. The first button 112 may be in mechanical communication with the second button 114 via the biased member 118. The first button 112 and the second button 114 may be moved simultaneously. At step 1830, the blade may be pivoted relative to the handle portion.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A foldable knife, comprising:
a handle portion having a first side and a second side opposite the first side, the handle portion defining a blade channel;
a blade pivotally coupled to the handle portion, wherein at least a portion of the blade is receivable in the blade channel;
a first button accessible on the first side of the handle portion, the first button including a first locking surface; and
a second button accessible on the second side of the handle portion, the second button including a second locking surface,
wherein the first locking surface and the second locking surface engage the blade to restrict pivotal movement of the blade relative to the handle portion.

2. The foldable knife of claim 1, wherein the first button is movable transversely relative to the first side of the handle portion and the second button is movable transversely relative to the second side of the handle portion.

3. The foldable knife of claim 2, wherein the first button is coupled to a biased member and the second button is coupled to the biased member.

4. The foldable knife of claim 1, wherein the blade includes a tang having a blade protrusion, wherein the first locking surface and the second locking surface engage the blade protrusion to restrict pivotal movement of the blade relative to the handle portion.

5. The foldable knife of claim 4, wherein the blade protrusion includes a first engagement surface extending transversely from a first side of the blade and a second engagement surface extending transversely from a second side of the blade, wherein the first locking surface engages the first engagement surface and the second locking surface engages the second engagement surface to restrict pivotal movement of the blade relative to the handle portion.

6. The foldable knife of claim 5, wherein the blade protrusion includes a first channel inboard from the first engagement surface and a second channel inboard from the second engagement surface.

7. The foldable knife of claim 4, wherein the blade protrusion is formed around a pivot aperture of the tang.

8. The foldable knife of claim 1, wherein the blade includes a tang having a pivot aperture and a curved slot, wherein the first button is mechanically coupled to the second button via a biased member extending through the curved slot.

9. A foldable knife, comprising:
a handle portion having a first side and a second side opposite the first side, the handle portion defining a blade channel;
a blade pivotally coupled to the handle portion, wherein at least a portion of the blade is receivable in the blade channel;
a first button accessible on the first side of the handle portion, the first button movable transversely relative to the first side of the handle portion between a first rest position and a first compressed position; and
a second button accessible on the second side of the handle portion, the second button movable transversely relative to the second side of the handle portion between a second rest position and a second compressed position,
wherein actuation of the first button to the first compressed position and the second button to the second compressed position enables pivotal movement of the blade relative to the handle portion.

10. The foldable knife of claim 9, wherein the first button positioned in the first rest position provides a first locking surface to engage the blade, and wherein the second button positioned in the second rest position provides a second locking surface to engage the blade.

11. The foldable knife of claim 10, wherein actuation of the first button to the first compressed position disengages the first locking surface from the blade and wherein actuation of the second button to the second compressed position disengages the second locking surface from the blade, and wherein actuation of only one of the first button or the second button is insufficient to enable pivotal movement of the blade relative to the handle portion.

12. The foldable knife of claim 9, wherein the blade includes a tang having a pivot aperture with a pivot axis, wherein the first button and the second button include a button axis extending therebetween, wherein the pivot axis does not intersect the button axis.

13. The foldable knife of claim 9, wherein the first button is mechanically coupled to a biased member and wherein the second button is coupled to the biased member, wherein the biased member extends across the blade channel.

14. The foldable knife of claim 13, wherein the biased member is biased to urge the first button to the first rest position and to urge the second button to the second rest position.

15. The foldable knife of claim 9, wherein the blade includes a longitudinal centerline and a tang having a blade protrusion, the blade protrusion including a first engagement surface extending transversely of the longitudinal centerline on a first side of the blade and a second engagement surface extending transversely of the longitudinal centerline on a second side of the blade.

16. The foldable knife of claim 15, wherein the blade protrusion includes a first channel positioned between the first engagement surface and the longitudinal centerline, and a second channel positioned between the second engagement surface and the longitudinal centerline.

17. A knife, comprising:
a handle portion;
a blade coupled to the handle portion; and
a removable scale configured to be removably secured to an exterior side of the handle portion.

18. The knife of claim 17, wherein the removable scale is magnetically securable to the handle portion.

19. The knife of claim 17, wherein the removable scale is mechanically securable to the handle portion by at least one of a friction fit, a snap fit, a clip fit, a sliding engagement, a lip, a tab, an overhang, or a mating engagement between a retention feature of the removable scale and a retention feature of the handle portion.

20. The knife of claim 17, further comprising a first button accessible on a first side of the handle portion and a second button accessible on a second side of the handle portion, wherein actuation of the first button and the second button enables pivotal movement of the blade relative to the handle portion, and wherein the removable scale defines an aperture, recess, opening, or clearance feature through
which the first button or the second button is accessible when the removable scale is secured to the handle portion.
